(19) United States
(12) Patent Application Publication
(10) Pub. No.: US 2016/0326051 A1
(43) Pub. Date: Nov. 10, 2016

(54) DEVICE FOR MANUFACTURING TEMPERED GLASS USING CHEMICAL STRENGTHENING AND MANUFACTURING METHOD THEREFOR

(71) Applicant: Ho Kwon KIM, Daegu (KR)

(72) Inventor: Ho Kwon KIM, Daegu (KR)

(21) Appl. No.: 15/109,383

(22) PCT Filed: Dec. 26, 2014
(86) PCT No.: PCT/KR2014/012871

§ 371 Date: Jun. 30, 2016

(30) Foreign Application Priority Data
Dec. 31, 2013 (KR) 10-2013-0168131

(51) Int. Cl. C03C 21/00; C03C 23/00

(52) U.S. Cl. CPC C03C 21/002; C03C 23/0075

(57) ABSTRACT

A device for manufacturing tempered glass using chemical strengthening and a manufacturing method therefor. The present invention manufactures tempered glass by raising the temperature of plate glass and preheating the plate glass at first and second preheating units step by step; substituting with potassium ions within a potassium nitrate solution of a chemical strengthening unit; cooling the plate glass through first and second slow cooling processes at first and second slow cooling units; and cleaning the plate glass by fine bubbles while securing stability of the glass at a cleaning unit. Due to this feature, the present invention can maximally shorten the process time for manufacturing tempered glass to considerably enhance yield and improve defect rate, and further can manufacture all types of plate glass such as thin plate glass and thick plate glass into chemically tempered glass regardless of the standard of plate glass.

### TECHNICAL FIELD

The present invention relates to a device for manufacturing tempered glass using chemical strengthening and a manufacturing method therefor, and more particularly, to a device for manufacturing tempered glass using chemical strengthening and a manufacturing method therefor in which compressive stress is added to a surface of glass to manufacture tempered glass by raising the temperature of plate glass and preheating the plate glass at first and second preheating units step by step, substituting with potassium ions within a potassium nitrate solution of a chemical strengthening unit, cooling the plate glass through first and second slow cooling processes at first and second slow cooling units, and cleaning the plate glass with fine bubbles with stability of the glass at a cleaning unit secured such that the process time for manufacturing tempered glass can be maximally shortened to considerably enhance yield and improve defect rate, and all types of plate glass such as thin plate glass and thick plate glass can be manufactured into chemically tempered glass regardless of the standard of plate glass.

### BACKGROUND ART

Generally, a raw material of glass is silicon dioxide (SiO₂), and glass formed only of SiO2 is referred to as quartz glass. The quartz glass has a melting point of about 1780° C., and the manufacturing cost thereof is high. However, when alkali metal oxides (Na₂O, Li₂O) are added, the melting point decreases to about 1280° C., and glass can be produced with low cost.

However, due to only having a tensile strength, glass is absolutely vulnerable to forces such as an impact, bending, etc.

Compressive stress is added to a surface of glass to increase the total tensile strength of the glass to be a sum of the added compressive stress and the tensile strength of the glass itself, thereby manufacturing tempered glass with an increased surface strength, impact resistance, bending stress, elongation, heat resistance, and cold resistance which is usable in all industrial fields such as for construction, industries, marine, ornaments, electronics, and home appliances.

Since the tempered glass is often used for a screen of a display device, a process for strengthening glass is required to manufacture tempered glass with excellent hardness and strength.

Commonly, strengthening of glass is mainly classified as physical strengthening and chemical strengthening. Generally, physical strengthening refers to a method of strengthening an inner strength of glass in which glass with a thickness of 5 mm or more is heated at a temperature between 550° C. and 700° C. and then rapidly cooled. Physical strengthening is mainly used for a tempered glass door, vehicular glass, etc.

While, as such, tempered glass is manufactured by etching strengthening, thermal strengthening, chemical strengthening, etc., chemical strengthening is applied to glass that includes alkali aluminosilicates and is a method of substituting small ions of a glass surface with large ions to generate compressive stress at the surface.

Chemical strengthening is a technology which was already developed in Japan about thirty years ago for a purpose of developing glass for clocks with 2.2 mm of thickness and 28 mm of diameter for watches.

The chemical tempering refers to strengthening glass by dipping thin plate glass in a strengthening furnace which contains a potassium nitrate solution for three hours or more and substituting sodium ions in the glass with potassium ions in the potassium nitrate solution, and is mainly used in strengthening thin plate glass having a thickness of 2.0 mm or less.

Recently, a manufacturing device has been suggested which is capable of manufacturing tempered glass through a method of performing ion exchange by having a small amount of molten rock salt contained in a melt which contains molten potassium salt to accelerate a speed of ion exchange reactions between potassium ions and sodium ions of a glass surface layer.

For example, various devices for manufacturing tempered glass are disclosed in related art documents including Korean Patent Registration No. 0659558, Korean Patent Registration No. 0864956, Korean Patent Registration No. 0914628, Korean Patent Registration No. 0937225, Korean Patent Registration No. 0966025, Korean Patent Registration No. 1061650, and Korean Patent Publication No. 2011-0135573.

FIG. 1 is a perspective view of a tempered glass manufacturing device which chemically manufactures tempered glass using a potassium nitrate solution.

As illustrated in FIG. 1, the tempered glass manufacturing device includes a main frame (1), guide rails installed parallel to each other at both vertical and horizontal sides of the main frame (1), a rack gear (11) which transmits power, a loading robot (2) and an unloading robot (3) which consecutively transfer a rack (12) on which multiple layers of glass are mounted along the guide rails (11) in the horizontal direction to allow the multiple layers of glass to be transferred to a preheating bath (4), a tempering bath (5), a slow cooling bath (6), a hot water bath (7), and a heat bath (8) to be tempered, wherein the rack (12) on which the multiple layers of tempered glass are mounted is carried to the outside. The tempered glass manufacturing device further includes a control box (13) which generally manages the tempered glass manufacturing device.

As above, the tempered glass manufacturing device includes the main frame (1) as a basic frame, the guide rails (11) installed parallel to each other at both vertical and horizontal sides of the main frame (1) so that robots may move parallel to each other, the preheating bath (4) which firstly heats glass before the glass is strengthened at an inner lower portion of the main frame (1) to prevent thermal deformation and cracking of the glass during strengthening of the glass, the tempering bath (5) which heats and melts KNO₃ therein and maintains KNO₃ in a molten state to adjust a tempering temperature, the slow cooling bath (6) which slowly cools a temperature of the glass tempered in the tempering bath (5) to remove stress, and the hot water bath (7) and the heat bath (8) which clean the tempered glass cooled in the slow cooling bath (6).

In this manner, in most of the tempered glass manufacturing devices according to the related art, several baths are installed apart from each other in the longitudinal direction, each of the baths includes an inner heating unit in which a heater is embedded, and a jig (or a rack) on which disk glass is loaded moving along a guide rail installed at an upper portion can be accommodated in each bath by lifting and lowering the jig.

In this manner, the disk glass to be tempered which is transferred in the process of tempering the disk glass is loaded on a jig and moved by the loading robot according to a process sequence, and the jig is seated in each bath by being lifted and lowered or is towed to be transferred.

Meanwhile, according to an embodiment of the related art, as illustrated in FIG. 2, a process of manufacturing tempered glass may be mainly classified into preparing plate glass (S1), preheating the plate glass (S2), chemically strengthening the plate glass (S3), and cooling and cleaning the plate glass (S4).

In this manner, a manufacturing method has been adopted for obtaining tempered glass by preheating plate glass prepared for manufacturing tempered glass in a preheating furnace, dipping the plate glass in KNO₃ in a main body furnace (or, a strengthening furnace) to chemically strengthen the plate glass, and post-processing the plate glass by cooling and cleaning in a slow-cooling furnace, a hot water furnace, and a cold water furnace so that the thickness of the plate glass is thin and stiffness and hardness of the plate glass is strengthened by an exchange of ions.

However, in the conventional process for preheating plate glass, a heater is disposed in one preheating furnace and plate glass is preheated approximately up to 300° C. to 400° C. to prevent damage and destruction of a structure of the plate glass that may occur when the plate glass is rapidly heated to a high temperature in the main body furnace (or the strengthening furnace).

However, due to raising the temperature of the plate glass approximately up to 300° C. to 400° C. and preheating the plate glass step by step in one preheating furnace according to the related art, a preheating time is long and thus a large amount of energy is consumed, and also, due to a wide temperature range between an initial preheating temperature when plate glass is inserted and a final preheating temperature, a waiting time after transferring completely preheated plate glass to the main body furnace until the next plate glass is supplied to the preheating furnace and a preheating process is performed again is long.

That is, a temperature inside the preheating furnace has to be lowered from the final preheating temperature (approximately 400° C.) to the initial preheating temperature (room temperature to approximately 100° C.) in a preparation step for preheating the next plate glass, but due to the extremely wide temperature range, the waiting time is necessarily long.

This of course acts as a cause of lowering overall manufacturing productivity since a rotation rate of using the preheating furnace naturally decreases as the process waiting time for using the preheating furnace becomes longer when tempered glass is continuously manufactured.

In addition, there are problems of long process time, low yield, and high defect rate due to damage of glass in a conventionally disclosed device and method for manufacturing tempered glass.

Particularly, demands on tempered glass have been gradually increasing recently, and this applies to both thin plate glass and thick plate glass. Since tempered glass is used in all fields such as heat-insulating or heat-reflecting glass, colored glass for an outer wall of a building, interior ornamental glass, and solar etching glass, development of a device for manufacturing chemically tempered glass that can be applied to glass of various thicknesses, forms, and sizes is demanded.

### DISCLOSURE

### Technical Problem

Thus, the present invention is a result of research and development for compensating and improving various disclosed problems of the conventional device for manufacturing tempered glass and a manufacturing method therefor, and it is an aspect of the present invention to provide a device for manufacturing tempered glass using chemical strengthening and a manufacturing method therefor in which compressive stress is added to a surface of glass to manufacture tempered glass by raising the temperature of plate glass and preheating the plate glass at first and second preheating units step by step, substituting with potassium ions within a potassium nitrate solution of a chemical strengthening unit, cooling the plate glass through first and second slow cooling processes at first and second slow cooling units, and cleaning the plate glass with fine bubbles with stability of the glass at a cleaning unit secured such that the process time for manufacturing tempered glass can be maximally shortened to considerably enhance yield and improve defect rate, and all types of plate glass such as thin plate glass and thick plate glass can be manufactured into chemically tempered glass regardless of the standard of plate glass.

It is another aspect of the present invention to provide a device for manufacturing tempered glass using chemical strengthening and a manufacturing method therefor in which plate glass is sequentially heated by a preheating furnace divided into first and second preheating furnaces in a process of preheating plate glass to be chemically strengthened such that a preheating time is shortened while a rotation rate in using the furnace is improved due to using the first and second preheating furnaces, and stable preheating is possible due to a decrease in energy consumption.

Particularly, it is yet another aspect of the present invention to provide a device for manufacturing tempered glass using chemical strengthening and a manufacturing method therefor in which a height control means and a width control means capable of changing vertical and horizontal widths according to a standard of plate glass are included inside a jig that mounts the plate glass when attempting to transfer plate glass which requires to be tempered in the tempered glass manufacturing device such that the plate glass can be stably loaded with one jig regardless of a change in the standard of the plate glass.

Further, it is an aspect of the present invention to provide a device for manufacturing tempered glass using chemical strengthening in which a heater disposed in each furnace is installed by being divided into each section such that the heater can be replaced and repaired for each section when the heater is failed and thus the heater can be easily managed.

In addition, it is another aspect of the present invention to provide a device for manufacturing tempered glass using chemical strengthening in which a KNO₃ solution remaining on a surface of tempered glass is more rapidly cleaned by circulating water and generating bubbles by a blower in a cleaning bath and a residual stress of the tempered glass is removed such that stabilization of the tempered glass can be improved.

### Technical Solution

To achieve the above objective, there is provided a method for manufacturing tempered glass using chemical strengthening which includes preparing plate glass so that plate glass having a predetermined standard is loaded on a jig and transferred to a furnace for each process by a transfer unit (S1), firstly preheating the plate glass in a first preheating furnace by repeatedly raising and fixing the temperature of the plate glass from room temperature to 200° C. step by step (S2), receiving the firstly-preheated plate glass and secondly preheating the plate glass in a second preheating furnace by repeatedly raising and fixing the temperature of the plate glass from 200° C. to 380° C. step by step (S3), receiving the secondly-preheated plate glass and dipping the plate glass in a KNO₃ solution heated up to 450° C. to 480° C. in a chemical strengthening furnace for thirty minutes to one hour to chemically strengthen the plate glass by ion substitution on a surface of the plate glass (S4), receiving the chemically-strengthened plate glass and firstly cooling the temperature of the plate glass up to 200° C. by repeatedly dropping and fixing the temperature of the plate glass step by step by air cooling in a first slow cooling furnace (S5), receiving the firstly-cooled plate glass and secondly cooling the temperature of the plate glass to 60° C. by repeatedly dropping and fixing the temperature of the plate glass step by step by air cooling in a second slow cooling furnace (S6), accommodating the secondly-cooled plate glass in a cleaning bath that contains hot water at 80° C. and then removing KNO₃ remaining on the surface of the plate glass by circulating foams and hot water using air supplied from a blower connected via pipes to an outer circumferential wall and a bottom surface of the cleaning bath (S7), and transferring the cleaned plate glass to a jig discharge unit for drying the plate glass by a natural drying method and finishing manufacturing of tempered glass (S8).

Here, a one-time temperature increase in raising the temperature of the plate glass step by step in the first and second preheating furnaces is preferably lower than 60° C., the one-time temperature increase can be controlled to be different according to a standard of plate glass, and a preheating time in each of the first and second preheating furnaces is preferably fifteen minutes.

Meanwhile, according to the present invention, there is provided a device for manufacturing tempered glass using chemical strengthening in which a jig supply unit that supplies a jig on which plate glass is loaded to be towed and accommodated in a transfer unit, a first preheating unit having the first preheating furnace capable of preheating plate glass transferred from the jig supply unit through the transfer unit, seated, and accommodated from room temperature up to 200° C. by heating the plate glass while repeatedly raising and fixing the temperature of the plate glass step by step by a heater, a second preheating unit having the second preheating furnace capable of receiving the plate glass preheated in the first preheating furnace and preheating the plate glass from 200° C. to 380° C. by heating the plate glass while repeatedly raising and fixing the temperature of the plate glass step by step by a heater, a chemical strengthening unit having the chemical strengthening furnace formed of a water bath on which a heater is mounted while a KNO₃ solution is retained therein so that the plate glass preheated in the second preheating furnace is received and dipped in the KNO₃ solution heated up to 450° C. to 480° C. for thirty minutes to one hour to enable ion substitution on a surface of the plate glass, a first slow cooling unit having the first slow cooling furnace that receives the plate glass chemically strengthened in the chemical strengthening furnace and cools the temperature of the plate glass to 200° C. by repeatedly dropping and fixing the temperature of the plate glass step by step by air cooling, a second slow cooling unit having the second slow cooling furnace that receives the firstly-cooled plate glass and secondly cools the temperature of the plate glass to 60° C. by repeatedly dropping and fixing the temperature of the plate glass step by step by air cooling, a cleaning unit having the cleaning bath that receives the secondly-cooled plate glass and uses hot water to clean and remove KNO₃ remaining on a surface of the plate glass, and the jig discharge unit that tows a jig on which the plate glass cleaned in the cleaning bath is loaded to the transfer unit to be discharged are sequentially and separately arranged on the first floor of a structure whose frame is formed by a plurality of support beams, and box-shaped transfer units with open bottom surfaces are disposed on the second floor of the structure to face each other at the jig supply unit and the jig discharge unit to tow, lift, and lower a jig on which plate glass is loaded according to a progress of each process while moving along a horizontally installed guide rail.

Here, the device for manufacturing tempered glass using chemical strengthening preferably includes a furnace accommodation frame having a shape of a frame formed by a plurality of support beams disposed to surround portions near a furnace to allow a jig transferred by the transfer unit to be accommodated in the furnace for each process and be towed, lifting-and-lowering frames disposed to be lifted and lowered by a cylinder not to interfere with an open surface at an upper end of the furnace on the furnace accommodation frame and, at the same time, seated and assembled to respectively face both side surfaces of the furnace accommodation frame, and an opening-and-closing door disposed on a rail beam integrally formed with upper ends of the lifting-and-lowering frames to extend relatively longer than the width of the furnace to be opened and closed by sliding along the rail beam toward both sides by an opening-and-closing means.

In addition, preferably, an inner wall of the furnace for each process is divided to be assembled by being divided into a plurality of sections, a support body having a form of a unit assembly corresponding to the size of the divided inner wall of each furnace is detachably disposed by an assembly bracket, and one heater is continuously disposed and fixed on the support body.

In addition, preferably, an air transfer pipe connected to the blower is disposed in a branched structure and connected via pipes to an outer wall of the cleaning bath to supply air inside the cleaning bath for cleaning the surface of the chemically strengthened plate glass with water, a plurality of blower connection pipes connected to the blower are disposed also at a lower end portion of the outer wall of the cleaning bath, and a perforated plate having a plurality of air holes is installed on an inner bottom surface of the cleaning bath.

### Advantageous Effects

According to the present invention, in adding compressive stress to a surface of glass to manufacture tempered glass, the process time for manufacturing tempered glass can be maximally shortened to considerably enhance yield and improve defect rate, and all types of plate glass such as thin plate glass and thick plate glass can be manufactured into chemically tempered glass regardless of the standard of plate glass.

In addition, according to the present invention, a preheating time is shortened while a rotation rate in using the furnace is improved due to using the first and second preheating furnaces, and stable preheating is possible due to a decrease in energy consumption.

In addition, according to the present invention, a height control means and a width control means capable of changing vertical and horizontal widths according to a standard of plate glass are included inside a jig that mounts plate glass, and the plate glass can be stably loaded with one jig regardless of a change in the standard of the plate glass. Thus, a separate jig for each standard of plate glass does not have to be prepared as in the related art, and using the jig is economically feasible.

In addition, according to the present invention, when installing a heater on an inner wall of each furnace to heat plate glass mounted on the jig in the tempered glass manufacturing device, a way of installing one continuous heater on a support body having the form of a unit assembly assembled and disposed by being divided to an inner surface of each furnace is adopted. Due to the heater disposed in each furnace being separately installed for each section, the heater can be replaced and repaired for each section when a heater is fails, the heater can be easily managed, and the replacement cost can be reduced.

Lastly, according to the present invention, pipes connected to a blower are configured to supply air to an outer wall and a lower end portion of a cleaning bath. Thus, as water is circulated and bubbles are generated due to the air supplied into the cleaning bath through the blower, a KNO₃ solution remaining on a surface of tempered glass is more rapidly cleaned by bubble cleaning and the cleaning efficiency is improved, and a residual stress of the tempered glass can be more easily removed since cleaning and cooling of the tempered glass are simultaneously performed such that stabilization of the tempered glass can be improved.

### DESCRIPTION OF DRAWINGS

FIG. 1 is a perspective view illustrating an embodiment of a tempered glass manufacturing device that chemically manufactures tempered glass according to the related art.

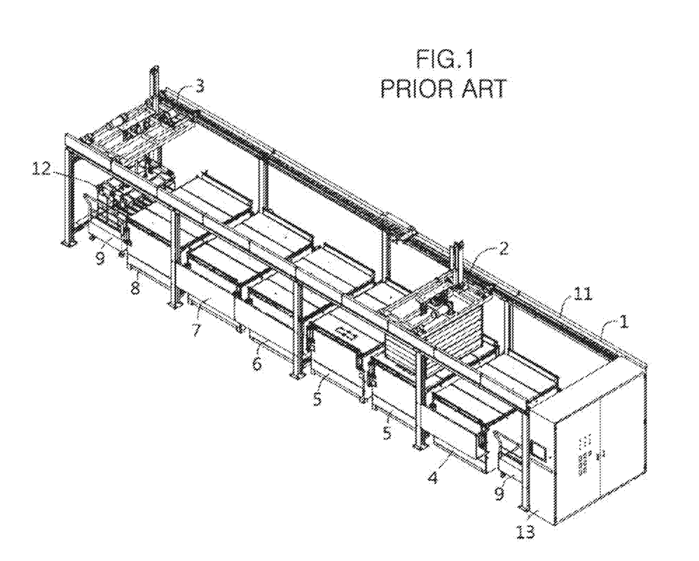

FIG. 2 is a process block diagram illustrating a schematic process order of a method for manufacturing tempered glass according to the related art.

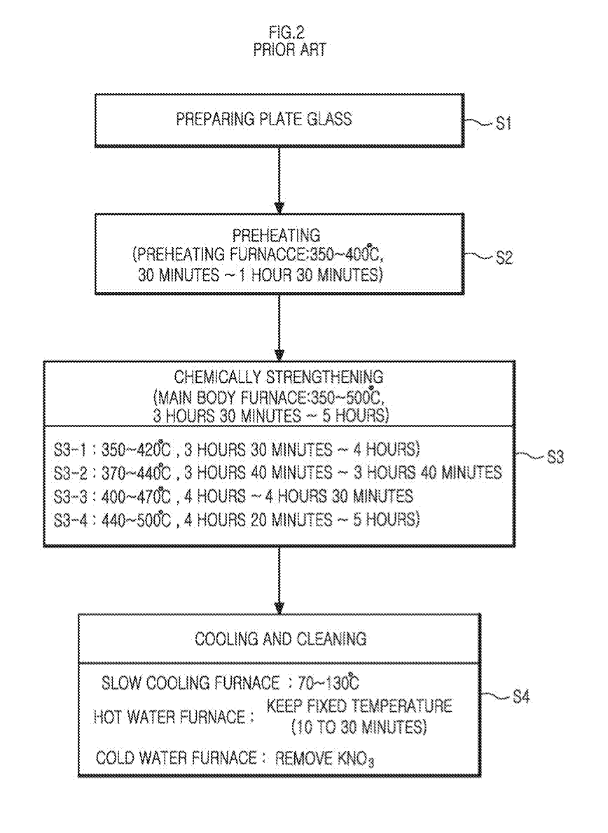

FIG. 3 is a process block diagram illustrating a schematic process order of a method for manufacturing tempered glass according to the present invention.

FIG. 4 is a front view illustrating an arrangement state of a tempered glass manufacturing device that chemically manufactures tempered glass according to the present invention.

FIG. 5 is a plan view of FIG. 4 illustrating the arrangement state of the tempered glass manufacturing device that chemically manufactures tempered glass according to the present invention.

FIG. 6 is a side view of FIG. 4 illustrating a state in which a jig inside a transfer unit has been transferred to an upper portion of a first preheating furnace in the tempered glass manufacturing device according to the present invention.

FIG. 7 is a perspective view illustrating a configuration of a jig capable of loading plate glass applied to the tempered glass manufacturing device according to the present invention.

FIG. 8 is a side view illustrating a jig lifting-and-lowering towing unit disposed at an upper portion of a transfer casing to lift and lower a jig in the tempered glass manufacturing device according to the present invention.

FIG. 9 is the other side view of FIG. 8 illustrating the jig lifting-and-lowering towing unit disposed at the upper portion of the transfer casing to lift and lower the jig in the tempered glass manufacturing device according to the present invention.

FIG. 10 is one side view schematically illustrating an opening-and-closing structure of an opening-and-closing door disposed at an upper portion of each furnace in the tempered glass manufacturing device according to the present invention.

FIG. 11 is an operation example view illustrating a state in which lifting-and-lowering frames are lifted by a cylinder for opening and closing the opening-and-closing door in the tempered glass manufacturing device according to the present invention.

FIG. 12 is an operation example view illustrating a state in which the opening-and-closing door is open while the lifting-and-lowering frames for opening and closing the opening-and-closing door are lifted in the tempered glass manufacturing device according to the present invention.

FIG. 13 is a configuration view illustrating an inner configuration of a first preheating furnace in the tempered glass manufacturing device according to the present invention.

FIG. 14 is a configuration view illustrating an inner configuration of a chemical strengthening furnace in the tempered glass manufacturing device according to the present invention.

FIG. 15 is a configuration view illustrating an inner configuration of a first slow cooling furnace in the tempered glass manufacturing device according to the present invention.

FIG. 16 is a configuration view illustrating an inner configuration of a cleaning furnace in the tempered glass manufacturing device according to the present invention.

### MODES OF THE INVENTION

Hereinafter, a preferred embodiment of the present invention will be described in detail with reference to the accompanying drawings.

Here, in describing the preferred embodiment of the present invention, thickness of lines or sizes of elements, etc. illustrated in the accompanying drawings may be exaggerated or omitted for clarity and convenience of description. Also, terms assigned according to reference numerals marked in the drawings are those defined in consideration of functions in the present invention and may be changed according to intentions or practices of a user or an operator.

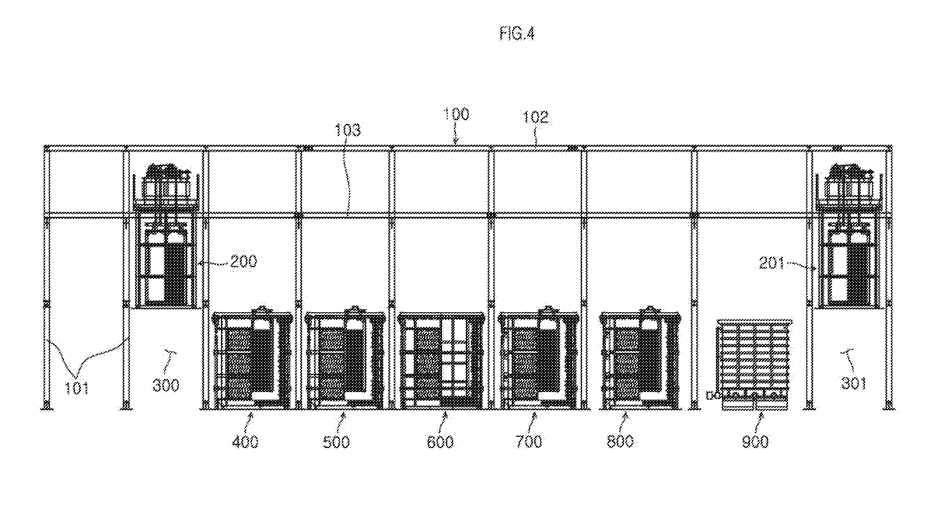

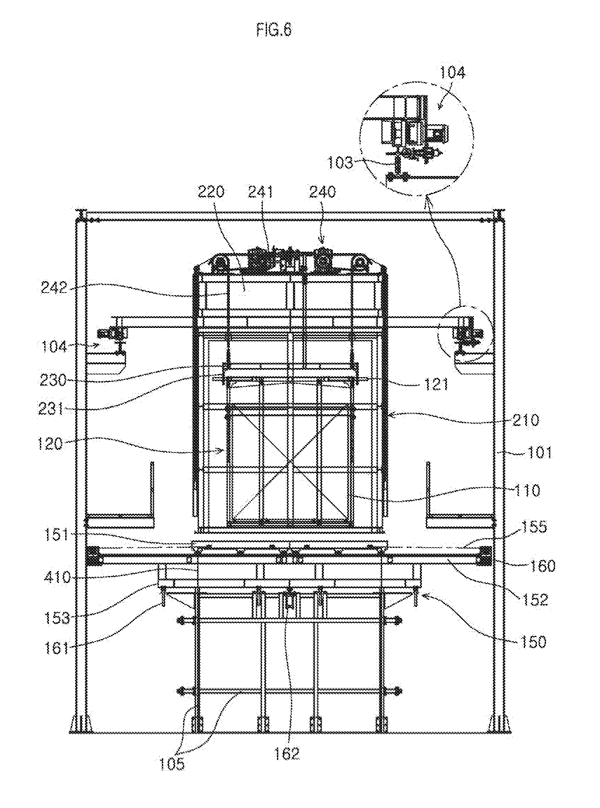

As illustrated in FIGS. 4 and 6, a tempered glass manufacturing device according to the present invention includes a structure 100 in which a series of devices required to perform each process such as transfer units 200 and 201, first and second preheating units 400 and 500, a chemical strengthening unit 600, first and second slow cooling units 700 and 800, a cleaning unit 900, and a jig discharge unit 301 are consecutively disposed in one line.

Here, the first and second preheating units 400 and 500, the chemical strengthening unit 600, the first and second slow cooling units 700 and 800, and the cleaning unit 900 are parts for performing each process of manufacturing plate glass 110 into tempered glass, and a furnace which is space capable of accommodating the plate glass 110 loaded on a jig 120 is disposed in each of the units.

For example, a furnace disposed in the first preheating unit 400 is referred to as a first preheating furnace 410, a furnace disposed in the chemical strengthening unit 600 is referred to as a chemical strengthening furnace 610, and a furnace disposed in the first slow cooling unit 700 is referred to as a first slow cooling furnace 710.

Here, the first and second preheating units 400 and 500, the chemical strengthening unit 600, the first and second slow cooling units 700 and 800, and the cleaning unit 900 are disposed on the first floor of the structure 100, and the transfer units 200 and 201 formed in the shape of a box having an open bottom surface are disposed to face each other at left and right sides to be movable along a guide rail 103 that is horizontally installed on the second floor of the structure 100.

As illustrated in FIGS. 4 and 6, the structure 100 is formed by steel frames such as H-beams erected at predetermined intervals and upper ends thereof connected to each other to be a large structure having hexagonal frames 101 and 102 (approximately, 31 m length×8 m width×10 m height in size).

Here, the first floor of the structure 100 is approximately 4 m high from the ground and is configured to arrange the transfer units 200 and 201, the first and second preheating units 400 and 500, the chemical strengthening unit 600, the first and second slow cooling units 700 and 800, and the cleaning unit 900 for each divided section as described above.

In addition, the second floor of the structure 100 is approximately 6 m high and has the guide rail 103 installed to face the longitudinal direction of the frame at approximately 7 m from the ground in the second floor of the structure 100 to allow transfer roller units 104 of the transfer units 200 and 201 move.

Here, as illustrated in FIGS. 4 and 6, the transfer units 200 and 201 are parts to sequentially transfer the plate glass 110 to be tempered to the first and second preheating units 400 and 500, the chemical strengthening unit 600, the first and second slow cooling units 700 and 800, and the cleaning unit 900, and perform roles of transferring, lifting, and lowering the plate glass 110 to each processing part according to a sequential process while the jig 120 for loading the plate glass 110 is disposed inside a transfer casing 210 formed of metal in a substantially rectangular shape.

The transfer units 200 and 201 include the transfer casing 210, a guide transfer block 220, a jig holding beam 230, and a lifting-and-lowering towing unit 240 to accommodate and transfer the jig 120.

Here, prior to describing configurations of the transfer units 200 and 201, the jig 120 transferred by being accommodated in the transfer units 200 and 201 will be described.

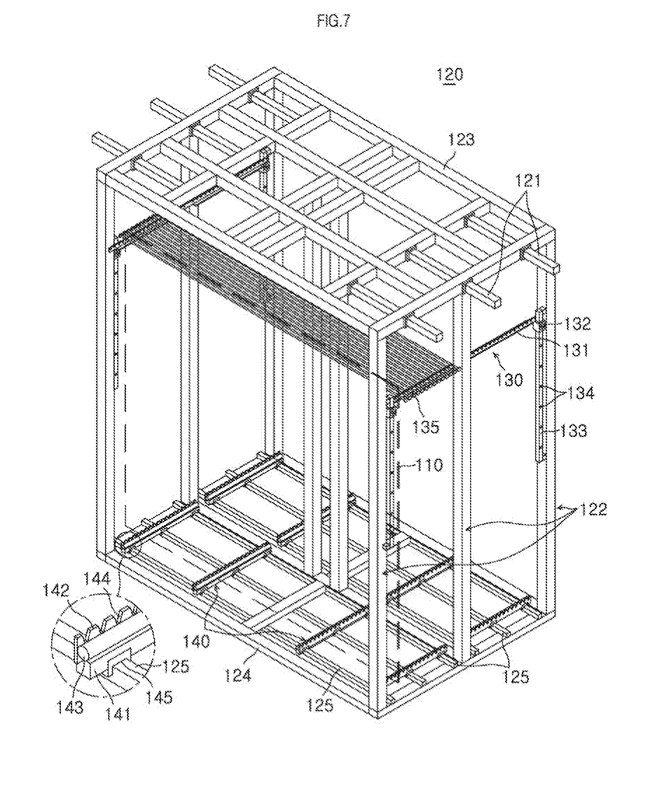

As illustrated in FIG. 7, the jig 120 is a part that firmly mounts and supports the plate glass 110 to be tempered by being inserted into each furnace according to each process, e.g. the first preheating furnace 410, to prevent the plate glass 110 from shaking and has a rectangular parallelepiped frame structure that has six side surfaces formed by framing a plurality of support beams disposed to face each other.

That is, the jig 120 has the rectangular parallelepiped frame structure formed of one pair of rectangular upper and lower frames 123 and 124 and side frames 122 formed by a plurality of support beams that connect the upper and lower frames 123 and 124.

Here, the upper and lower frames 123 and 124 are preferably formed by framing at least one support beam having a rectangular cross-section in horizontal and vertical directions inside a rectangular space for the strength of the frame structure.

In addition, a hanging shaft 121 on which a hook 231 for lifting the jig 120 by the lifting-and-lowering towing unit 240 is formed to protrude from both side surfaces of the upper frame side of the jig 120.

In addition, the jig 120 is configured such that the plate glass 110 can be stably mounted by controlling a mounting width and a mounting height corresponding to various standards of the plate glass 110 only with one jig 120 regardless of a change in the standard of the plate glass 110.

For this, the jig 120 has a height control means 130 and a width control means 140 capable of mounting the plate glass in various ways according to the standard of the plate glass inside the jig 120.

The height control means 130 are installed to be vertically movable when a mounting height needs to be changed according to a height (a vertical length) of the plate glass 110.

The height control means 130 are disposed at both upper side surfaces of the side frames 122 to face each other and be horizontal to the width control means 140.

Here, the height control means 130 include side slot bars 131 in which a plurality of slot grooves are formed, height control guide beams 133 vertically disposed along the side frames 122 to be perpendicular to the side slot bars 131 and having a plurality of height control holes 134 formed at predetermined intervals, and fixing ports 132 movably assembled to the height control guide beams 133 to change or fix positions of the side slot bars 131.

The plurality of slot grooves formed at the side slot bars 131 are grooves to which support pin bars 135, which are adhered to and support an upper end of the plate glass 110, are fitted and fixed, and have a substantially rounded groove structure.

The support pin bars 135 are fitted to the slot grooves of the side slot bars 131 disposed to face each other at both side surfaces of the side frames 122 to cross the slot grooves to perform a role of adhering to and supporting the upper end of plate glass 110.

The height control guide beams 133 are members that guide height adjustment of the side slot bars 131, are vertically disposed in a structure of facing each other on sides of four corners that form the side frames 122, and include a plurality of height control holes 134 formed at predetermined intervals to adjust a height at which the side slot bars 131 are installed corresponding to a height (a horizontal length) of the plate glass 110.

The fixing ports 132 that support and fix both ends of the side slot bars 131 are disposed at the height control guide beams 133, and fixing pins fitted and fixed to correspond to the height control holes 134 are detachably disposed at the fixing ports 132.

The width control means 140 is a part that supports a lower end surface of the plate glass 110 mounted inside the jig 120 and includes a plurality of width control slot bars 142 capable of being moved so that positions of support points may be changed along a width length of the plate glass 110, a round bar 143 adhered to and fixed to side surfaces of the width control slot bars 142 to support a lower end of the plate glass 110 by coming into contact with the lower end surface of the plate glass 110, and a movement bar 141 including a plurality of guide grooves 145 formed to be movable along rails 125 while supporting the width control slot bars 142 and the round bar 143.

Since the rails 125 are disposed to extend in a length direction of the lower frame 124 (a longitudinal direction of the rectangular frame), three rails 125 form one group, and two groups of three guide rails 125 are disposed to be horizontally symmetrical to each other with respect to a central line of the lower frame 124.

The movement bar 141 has a rectangular cross-sectional structure and is disposed in a structure that is perpendicular to the plurality of rails 125 disposed in the long direction (or refers to the longitudinal direction in the rectangular space) inside the lower frame 124.

Here, the movement bar 141 has a structure in which the plurality of guide grooves 145 fitted and coupled to the plurality of rails 125 to be movable along the rails 125 are formed at a bottom surface of the movement bar 141.

The width control slot bars 142 have a structure in which a plurality of seating grooves 144 formed substantially in a V-shape having a predetermined angle are repeatedly formed along the longitudinal direction so that the plate glass 110 may be easily fitted while being integrally coupled to the movement bar 141.

While the plate glass 110 is being transferred or fixed, the seating grooves 144 firmly support the plate glass 110, mount the plate glass 110 to prevent the plate glass 110 from being deviated, and prevent damage to a surface of the plate glass 110 by linear contact.

That is, the seating grooves 144 minimize an area coming into contact with the plate glass 110 to minimize cracks and faults that may occur while the plate glass 110 is being transported and tempered.

In addition, the round bar 143 having a circular cross-section that comes into contact with and supports the lower end of the plate glass 110 fitted and mounted on the seating grooves 144 is adhered and fixed to side surfaces of the seating grooves 144 of the width control slot bars 142.

Consequently, when the plate glass 110 is fitted and mounted on the seating grooves 144, the lower end of the plate glass 110 is placed on the round bar 143 such that a lower end portion of the plate glass 110 can be mounted while not being caught in the seating grooves 144 formed substantially in a V-shape, and the plate glass 110 may be stably supported and mounted with a sufficient strength by the round bar 143 even when a self-load of the plate glass 110 is extremely heavy due to a large standard of the plate glass 110.

Here, the width control slot bars 142 and the round bar 143 are integrally coupled and fixed to an upper end portion of the movement bar 141 having a rectangular cross-section by coupling means such as welding.

As described above, by having the height control means 130 and the width control means 140 disposed inside the jig 120, when the standard of the plate glass 110 changes, positions of the height control means 130 and the width control means 140 are changed corresponding to the standard of the plate glass 110, and thus various standards of the plate glass 110 can be stably mounted without replacing the jig 120.

Hereinafter, configurations of the transfer units 200 and 201 that accommodate and transfer the jig 120 configured as above will be described.

First, for rapid performance of the process and convenience, the transfer units 200 and 201 are respectively disposed at left and right sides of the structure 100 and perform a role of transferring the jig 120 on which the plate glass 110 is loaded to a furnace of each process from left and right sides of the structure 100.

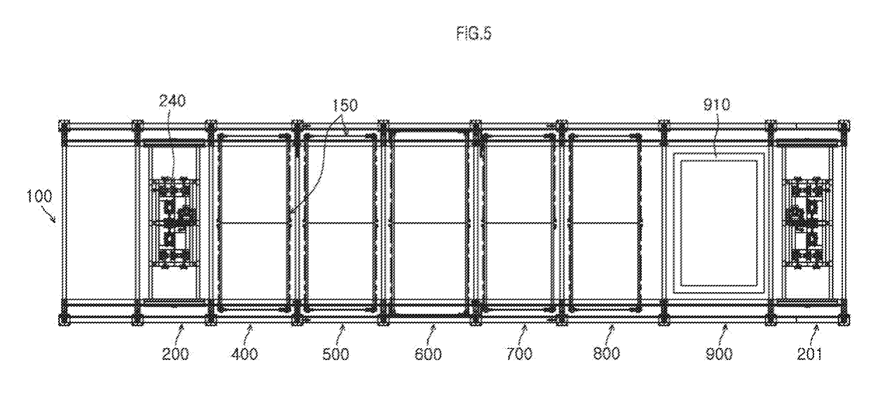

That is, the transfer unit 200 disposed at the left side on the accompanying drawings FIGS. 4 and 5 is in charge of transferring the jig 120 from the first and second preheating units 400 and 500 to the chemical strengthening unit 600, and the transfer unit 201 disposed at the right side on the accompanying drawings FIGS. 4 and 5 is in charge of transferring the jig 120 from the first and second slow cooling units 700 and 800 to the cleaning unit 900.

As different transfer areas are allocated to each of the transfer units 200 and 201, detailed inner configurations of the transfer units 200 and 201 disposed to face each other are quite different from each other.

That is, since processes of preheating and heating the plate glass 110 up to a predetermined temperature level for chemical strengthening of the plate glass 110 are performed in the first and second preheating units 400 and 500 and the chemical strengthening unit 600, a separate heating device (not illustrated) for maintaining a temperature is preferably disposed in the transfer casing 210 of the transfer unit 200 disposed near a jig supply unit 300 to keep the temperature of the preheated and heated plate glass 110 without dropping in a process of being transferred by the transfer unit 200.

On the other hand, since a process of stably dropping the temperature of the chemically strengthened plate glass 110 is performed at the first and second slow cooling units 700 and 800 and the cleaning unit 900, a temperature does not have to be maintained in the transfer casing 210 of the transfer unit 201 disposed near a jig discharge unit 301, and thus a separate heating device (not illustrated) is not disposed.

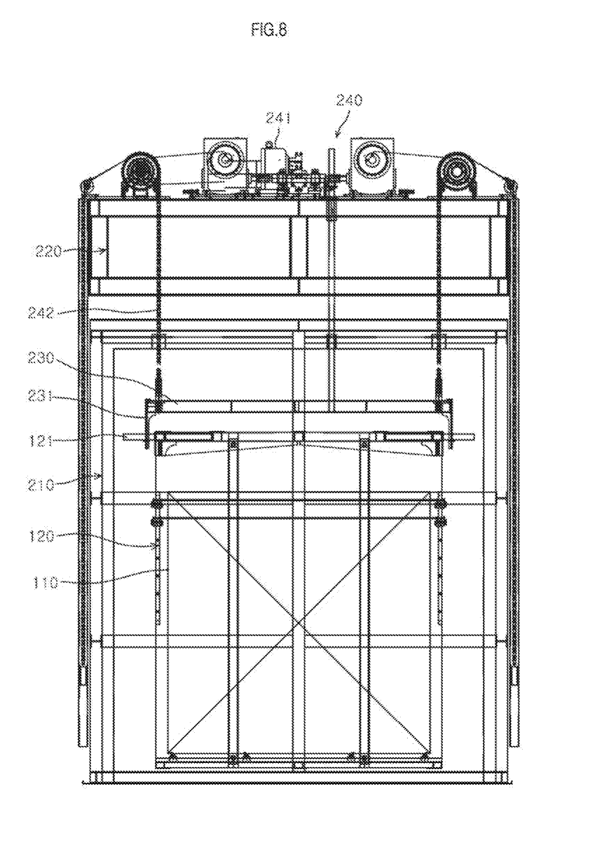

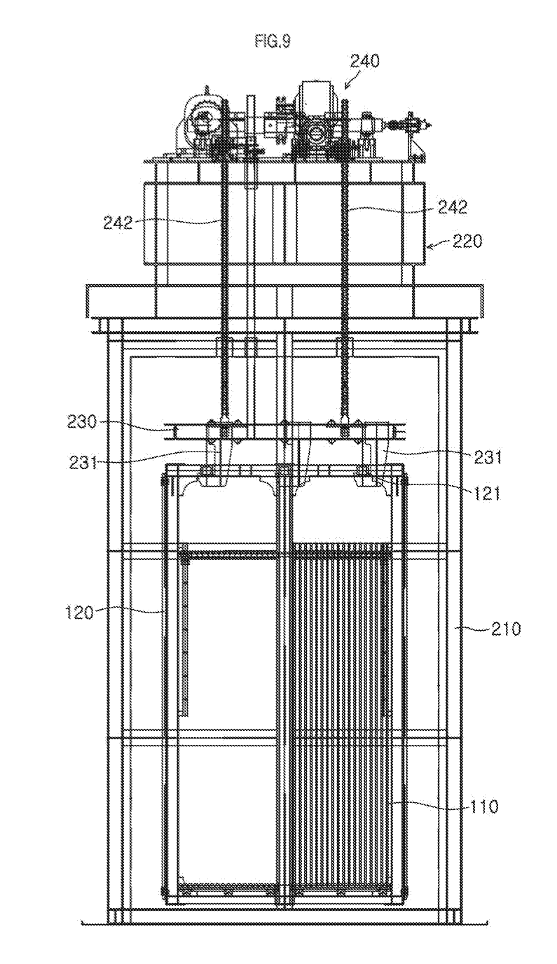

Meanwhile, as illustrated in FIGS. 8 and 9, the transfer casing 210 is formed of a metal material in a substantially rectangular shape, has an open lower end surface, and is configured to accommodate the jig 120 on which the plate glass 110 is loaded.

The guide transfer block 220 is disposed at an upper end of the transfer casing 210 to serve as a support plate on which the transfer roller units 104 and the lifting-and-lowering towing unit 240 for transferring the transfer units 200 and 201 toward an upper portion of the furnace for each process are disposed.

The jig holding beam 230 is a part that holds and supports the jig 120 from the top by hanging, and, as illustrated in FIGS. 6, 8, and 9, includes the hook 231 to tow by being hung on the hanging shaft 121 formed to protrude from both sides surfaces of the jig 120 while disposed in the transfer casing 210.

The hook 231 is formed in a structure having the shape of a hook to be detachably coupled to the hanging shaft 121 of the jig 120, and the hook 231 provides a structure capable of stably towing the jig 120 from the top by being assembled and coupled to tow by being hung on the hanging shaft 121 of the jig 120.

The lifting-and-lowering towing unit 240 is a jig lifting-and-lowering device that performs a role of towing the jig 120 according to each process to accommodate or withdraw the jig 120 in or from each furnace, e.g., the first preheating furnace 410.

The lifting-and-lowering towing unit 240 is fixed and installed at an upper end surface of the guide transfer block 220 to perform a role of hanging and holding four parts of the jig 120 to be stably towed using a lifting-and-lowering chain 242 and the jig holding beam 230 by a driving force of a motor 241 and then lifting and lowering the jig 120 in a vertical direction through the open bottom surface within the transfer casing 210.

The lifting-and-lowering chain 242 is formed in a structure in which, while being wound around a chain sprocket at least once, one end is suspended downward in the form of a free end and the other end is connected and fixed to the jig holding beam 230.

Consequently, according to the tempered glass manufacturing device according to the present invention illustrated in FIGS. 6, 8, and 9, multiple sheets of plate glass 110 to be tempered are mounted on the jig 120, and the transfer unit 200 illustrated in FIG. 6 moves the jig 120 to each process part for the tempered glass manufacturing process while moving along the guide rail 103.

Meanwhile, as illustrated in FIGS. 6, 10, and 12, an opening-and-closing means 150 that includes an opening-and-closing door 151 that moves along a rail beam 152 to selectively open and close an open surface at each upper end of the first and second preheating units 400 and 500, the chemical strengthening unit 600, and the first and second slow cooling units 700 and 800 is installed between the first floor and the second floor of the structure 100.

The opening-and-closing means 150 is a device to open and close the open surface at the upper end of the furnace to accommodate and tow the jig 120 transferred by the transfer unit 200 in the furnace for each process.

The opening-and-closing means 150 has a configuration that mainly includes the opening-and-closing door 151 opened and closed by driving a chain by an opening-and-closing motor (160, refer to FIG. 7), a lifting-and-lowering frame 153 that lifts and lowers while including the rail beam 152 that supports and guides the opening-and-closing door 151, and a cylinder 162 that provides a lifting-and-lowering power of the lifting-and-lowering frame 153.

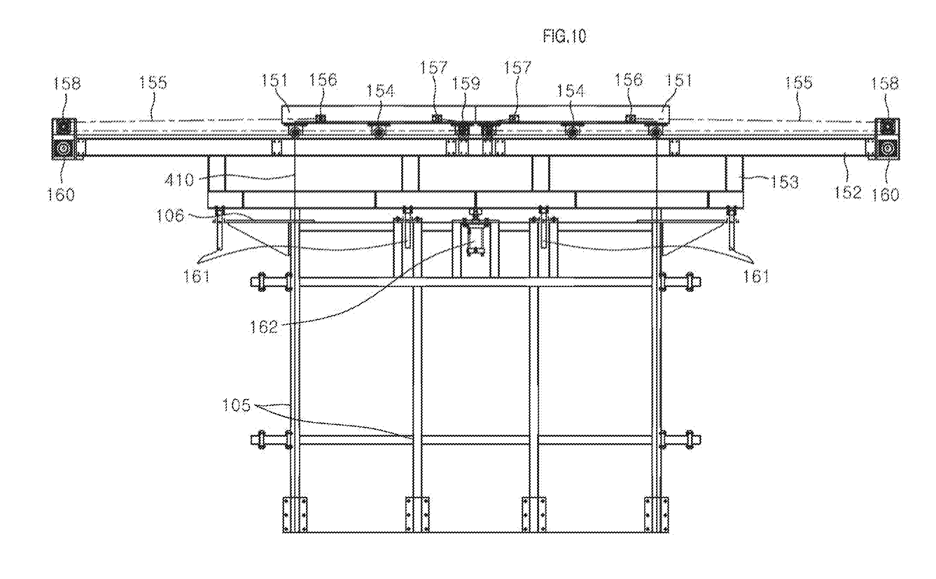

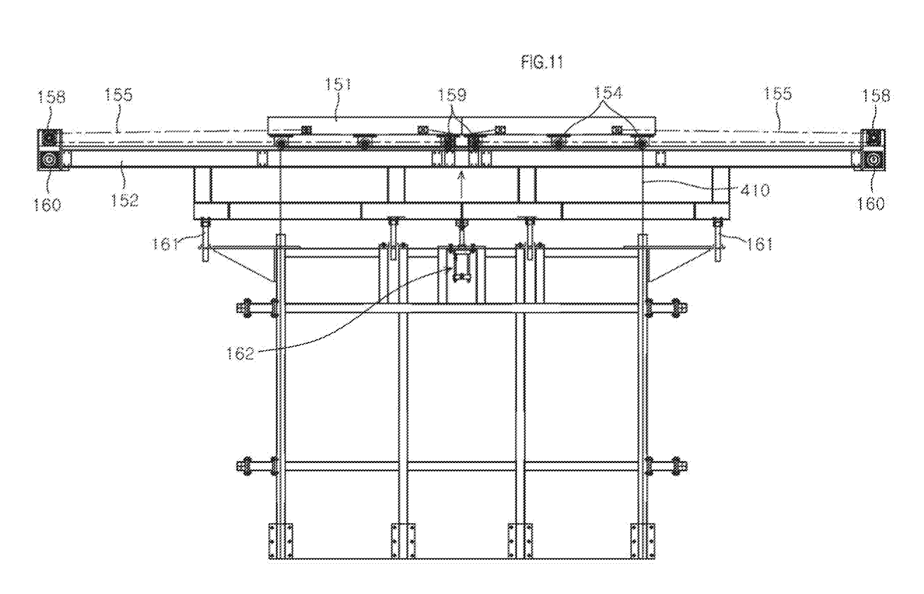

Hereinafter, since the opening-and-closing doors 151 are disposed in the same way at upper portions of furnaces respectively disposed in the first and second preheating units 400 and 500, the chemical strengthening unit 600, and the first and second slow cooling units 700 and 800, and the opening-and-closing means 150 to open and close the opening-and-closing doors 150 all have the same configuration, one preferred embodiment will be described by focusing on the first preheating furnace 410 disposed in the first preheating unit 400 as illustrated in FIGS. 10 to 12.

First, as illustrated in the drawings, a furnace accommodation frame 105 is disposed by surrounding portions near the first preheating furnace 410, and the furnace accommodation frame 105 has the shape of a frame formed by a plurality of support beams.

That is, a furnace for each process (in the present invention, the first preheating furnace 410 will be mainly described as an example) is accommodated and disposed inside the furnace accommodation frame 105.

Here, since an upper end of the first preheating furnace 410 is open, the opening-and-closing door 151 which is a cover capable of opening and closing the open surface at the upper end of the first preheating furnace 410 is installed to prevent foreign substances form entering the first preheating furnace 410 and prevent a temperature inside the first preheating furnace 410 from rapidly leaking to the outside.

The opening-and-closing door 151 has a design structure capable of covering the open surface at the upper end of the first preheating furnace 410 while being maximally seated on the open surface of the upper end of the first preheating furnace 410. Due to this structural design feature, when the opening-and-closing door 151 is simply slid to be opened and closed at the upper end of the first preheating furnace 410, an interference may occur between the upper end of the first preheating furnace 410 and the opening-and-closing door 151.

Accordingly, a structural design to allow the opening-and-closing door 151 to be lifted upward before being opened and closed is provided in the present invention. Thus, the opening-and-closing door 151 is installed on the lifting-and-lowering frame 153 capable of lifting and lowering, and the lifting-and-lowering frame 153 is disposed in a structure of facing upper ends of both side surfaces of the furnace accommodation frame 105.

The lifting and lowering of the lifting-and-lowering frame 153 is performed by the cylinder 162.

Since the cylinder 162 is fixed and disposed between the furnace accommodation frame 105 and the lifting-and-lowering frame 153, a piston of the cylinder 162 is installed in a structure of being connected to and supported by a bottom surface of the lifting-and-lowering frame 153 while being fixed on the furnace accommodation frame 105.

Here, the cylinder 162 is preferably disposed near center portions of both side surfaces of the lifting-and-lowering frame 153 so that the lifting-and-lowering frame 153 can be lifted in balance.

In case of the present invention, although the cylinder 162 is implemented as being disposed at each of the both side surfaces of the lifting-and-lowering frame 153, embodiments are not limited to the structure, and of course design may be changed as needed so that all sides of the lifting-and-lowering frame 153 can be lifted in balance with a distributed force using a plurality of cylinders 162.

In addition, a plurality of guide shafts 161 are fixed and disposed at predetermined intervals on the bottom surface of the lifting-and-lowering frame 153 so that the lifting-and-lowering frame 153 can be stably lifted and lowered by an operation of the cylinder 162 at the upper end surface of the furnace accommodation frame 105.

Of course, slide support holes 166 that guide lifting-and-lowering slides of the guide shafts 161 while the guide shafts 161 are inserted and assembled thereto are formed at the furnace accommodation frame 105 to face the guide shafts 161.

Particularly, since a length of the bottom surface of the lifting-and-lowering frame 153 is formed to extend to be relatively longer than a length of the upper end of the furnace accommodation frame 105 and the guide shafts 161 are installed also near an edge of the bottom surface of the lifting-and-lowering frame 153, an auxiliary support beam 106 is disposed to extend to both sides of the upper end of the furnace accommodation frame 105 by a length corresponding to the length of the bottom surface of the lifting-and-lowering frame 153, and the slide support holes 166 are disposed on the auxiliary support beam 106 to face the guide shafts 161 to assemble and guide the guide shafts 161.

In addition, the rail beam 152 formed by extending relatively longer than the width of the first preheating furnace 410 is integrally disposed at an upper end of the lifting-and-lowering frame 153, and the opening-and-closing door 151 is disposed on the rail beam 152 to be slidable by receiving power caused by the opening-and-closing means 151.

The rail beam 152 has an H-beam structure and has a structure in which a rail with a circular cross-section is integrally formed at an upper end surface thereof, and a plurality of rollers 154 disposed on the bottom surface of the opening-and-closing door 151 are coupled to the rail at the upper end of the rail beam 152 to be slidably assembled.

In this manner, while the opening-and-closing door 151 is disposed in a structure capable of being lifted and lowered by the lifting-and-lowering frame 153, a horizontal sliding opening-and-closing movement of the opening-and closing door 151 is performed by receiving a driving force of the opening-and-closing motor 160.

In this way, the opening-and-closing means 150 for transmitting power to open and close the opening-and-closing door 151 has a configuration including the plurality of rollers 154 disposed at both sides of the bottom surface of the opening-and-closing door 151 being slid, opened, and closed to face each other to slide along the rail on the rail beam 152 at both sides, first pulleys 158 and 165 respectively disposed at both end sides of the rail beam 152 at both sides, second pulleys 159 and 159 formed at a central portion of the rail beam 152 to form a pair to respectively face the first pulleys 158 and 165, a chain 155 having both ends respectively fixed to fixing brackets 156 and 157 disposed at a predetermined interval on both side surfaces of each opening-and-closing door 151 while being wound between the first pulleys 158 and 165 and the second pulleys 159 and 159, the opening-and-closing motor 160 connected to and disposed at a lower end of the first pulley 158 to provide a driving force for the chain 155 to open and close the opening-and-closing door 151 by back and forth movements with respect to the first pulleys 158 and 165 and the second pulleys 159 and 159, and an interlocking shaft 164 connected and disposed to transmit power to the first pulley 165 disposed on the rail beam 152 at an opposite side so that the first pulley 165 interlocks with the first pulley 158 near the opening-and-closing motor 160.

The first pulleys 158 and 165 and the second pulleys 159 and 159 each forming one pair are disposed to face each other to be connected to the opening-and-closing motor 160 to open and close the opening-and-closing door 151 toward both sides by the chain 155 to support power transmission, and are implemented in the shape of a chain sprocket to stably drive the chain 155.

In addition, the fixing brackets 156 and 157 provided at predetermined intervals at both side surfaces of the opening-and-closing door 151 perform a role of fixing support points that fix both ends of the chain 155. Power of the opening-and-closing motor 160 is transmitted to the opening-and-closing door 151 as the chain 155 moves back and forth between the first pulleys 158 and 165 and the second pulleys 159 and 159 when the opening-and-closing motor 160 operates while the chain 155 is fixed by the fixing brackets 156 and 157 as the fixing support points.

Meanwhile, although not illustrated, when opening-and-closing doors 151 at both sides adhere to each other in a process of being restored to an initial state and being closed from an open state, a limit switch that comes in contact with and detects a position of the opening-and-closing door 151 is preferably installed at a position at which the opening-and-closing door 151 is closed for controlling the operation of the opening-and-closing motor 160 to be stopped.

A schematic operational process of the tempered glass manufacturing device having the configuration above is as follows.

First, according to the tempered glass manufacturing device according to the present invention illustrated in FIGS. 4 to 6, multiple sheets of plate glass 110 to be tempered are mounted on the jig 120, and the jig 120 on which the plate glass 110 is mounted is accommodated in the transfer casing 210 of the transfer unit 200 by the jig supply unit 300 illustrated in FIG. 4.

Here, the jig 120 is towed by the lifting-and-lowering towing unit 240 disposed at the transfer unit 200.

In addition, the transfer unit 200 moves the jig 120 to the first preheating unit 400 to perform a preheating process which is the first process of the tempered glass manufacturing process while moving along the guide rail 103 by the transfer roller units 104 of the guide transfer block 220.

When the transfer unit 200 moves to the upper portion of the first preheating unit 400, the opening-and-closing door 151 that has closed the first preheating furnace 410 of the first preheating unit 400 is opened to accommodate the jig 120.

That is, as illustrated in FIGS. 6, 10, and 12, the cylinder 162 disposed between the furnace accommodation frame 105 and the lifting-and-lowering frame 153 operates to push the lifting-and-lowering frame 153 upward by the piston.

Here, since a lifting state of the guide shafts 161 disposed at the bottom surface of the lifting-and-lowering frame 153 is guided by the slide support holes 166 formed at the furnace accommodation frame 105 and the auxiliary support beam 106, the lifting-and-lowering frame 153 is stably lifted without shaking.

When the lifting-and-lowering frame 153 is pushed to the upper portion of the first preheating furnace 410 in this way, since the opening-and-closing door 151 is lifted from the open surface at the upper end of the first preheating furnace 410, an interference between the upper end surface of the first preheating furnace 410 and the opening-and-closing door 151 is prevented.

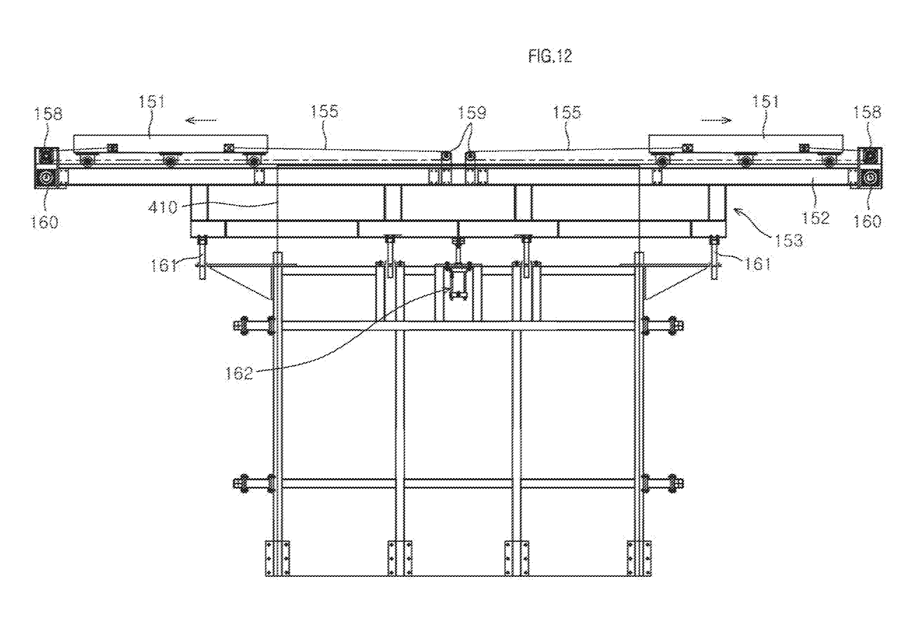

When the lifting-and-lowering frame 153 is lifted in this way, as illustrated in FIG. 12, the opening-and-closing motor 160 operates to open the opening-and-closing door 151 by sliding the opening-and-closing door 151 toward both sides on the rail beam 152.

That is, when the opening-and-closing motor 160 operates to drive the first pulley 158, the interlocking shaft 164 connected to the first pulley 158 rotates together and drives the first pulley 165 on the rail beam 152 at the opposite side. Accordingly, the chain 155 having both ends connected and fixed to the fixing brackets 156 and 157 near the opening-and-closing door 151 operates while being wound around the first pulleys 158 and 165 and the second pulleys 159 and 159 to slide the opening-and-closing door 151 in the opening direction.

In addition, when the opening-and-closing door 151 is opened and the open surface at the upper end of the first preheating furnace 410 is opened, the jig 120 accommodated in the transfer unit 200 is lowered by the lifting-and-lowering towing unit 240 and seated in the first preheating furnace 410.

Then, when the opening-and-closing motor 160 rotates in the direction opposite from that in which the opening-and-closing door 151 is opened, the opening-and-closing door 151 is restored to the initial state and closed by an operational process that is opposite from the opening process. In this state, by lowering the lifting-and-lowering frame 153 and allowing the opening-and-closing door 151 to be seated on the open surface at the upper end of the first preheating furnace 410 to close the open surface by an operation of the cylinder 162, airtightness can be maximally maintained.

In this manner, preparation for preheating is finished when the plate glass 110 loaded on the jig 120 is seated in the first preheating furnace 410.

Particularly, means for transferring the plate glass 110 loaded on the jig 120 according to each process by the transfer units 200 and 201 as above to perform the tempered glass manufacturing method are the same.

Consequently, since a process of transferring and seating the plate glass 110 in furnaces for other processes can be fully understood with reference to the description on transferring and seating the plate glass 110 loaded on the jig 120 in the first preheating furnace 410, detailed description on a transfer process for each process will be omitted.

Meanwhile, major elements of the tempered glass manufacturing device according to the present invention required in the process of transferring the plate glass to the furnace for each process by the jig have been described above. Thus, hereinafter, a manufacturing method for chemically strengthening plate glass will be examined.

In this case, hereinafter, a configuration of each furnace that performs each process will be examined, and a manufacturing process implemented by the configuration of each furnace will be examined.

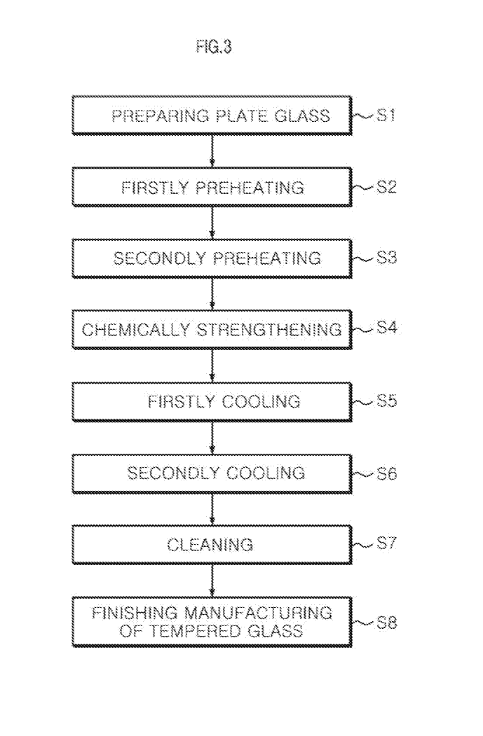

As illustrated in FIG. 3, the tempered glass manufacturing method according to the present invention mainly includes preparing plate glass (S1), firstly preheating the plate glass (S2), secondly preheating the plate glass (S3), chemically strengthening the plate glass (S4), firstly cooling the tempered glass (S5), secondly cooling the tempered glass (S6), cleaning the tempered glass (S7), and finishing the manufacturing of the tempered glass (S8).

Here, the preparing of the plate glass (S1) is a step of loading the plate glass 110 required to be tempered on the jig 120 and transferring the plate glass 110 up to the first preheating process by the transfer unit 200.

Since a technical description on each element that performs the preparing of the plate glass (S1) has already been given above, a detailed description thereof will be omitted.

Here, the chemical strengthening process can be performed by loading the plate glass 110 used in the present invention ranging from a small sheet of glass (150 mm×150 mm or smaller) to a large sheet of glass (3,048 mm×3,048 mm or larger) by one jig 120.

When the plate glass preheating process according to the present invention is compared to the conventional plate glass preheating process, although all preheating processes are performed in one preheating furnace conventionally, the process of preheating the plate glass 110 is performed by being subdivided into first preheating and second preheating in the case of the present invention.

That is, as illustrated in FIGS. 4 and 5, the first preheating unit 400 and the second preheating unit 500 are included as units that perform the process of preheating the plate glass 110, and the first preheating furnace 410 and a second preheating furnace (not marked) are respectively disposed in the first and second preheating units 400 and 50X).

Of course, configurations and structural features of the first preheating furnace 410 and the second preheating furnace (not marked) respectively disposed in the first preheating unit 400 and the second preheating unit 500 are the same.

Consequently, in the description of the present invention, the second preheating furnace may also be fully understood even when configurations and structural features are described only with respect to the first preheating furnace 410.

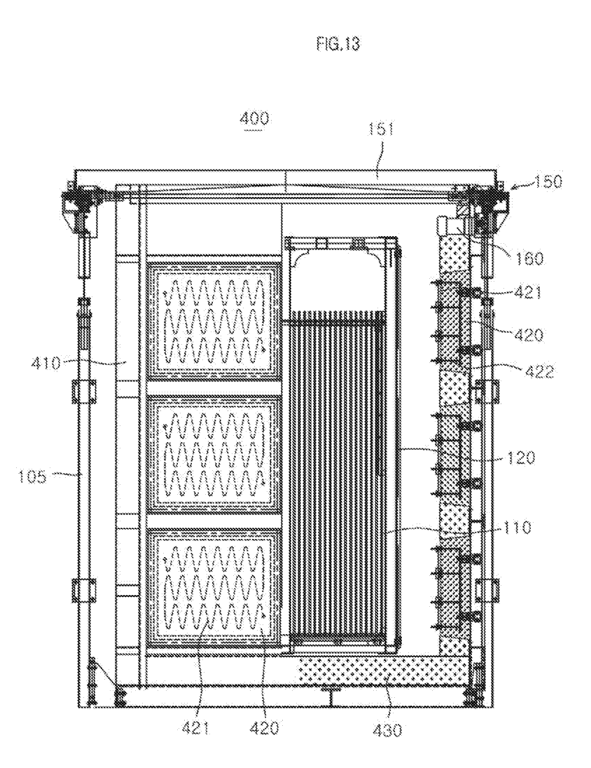

A schematic view illustrating a configuration of the first preheating furnace according to the present invention is illustrated in FIG. 13.

As illustrated in FIG. 13, the first preheating furnace 410 disposed in the first preheating unit 400 according to the present invention has a box-shaped container structure with an open upper portion, and an insulator 430 for keeping warmth is inserted into an inner wall and a bottom surface thereof.

Of course, the opening at the upper end of the first preheating furnace 410 is sealed to be opened and closed by the opening-and-closing door 151.

In addition, a heater 421 disposed by being divided into a plurality of sections is disposed in the inner wall of the first preheating furnace 410.

Particularly, according to the present invention, in mounting the heater 421 on the first preheating furnace 410, a support body 420 that supports the heater 421 is configured to be formed by the inner wall of the first preheating furnace 410.

That is, the support body 420 has an insulation property, and a fixing bracket 422 capable of supporting and fixing the heater 421 is inserted therein.

Since the support body 420 may be manufactured and formed in the form of a unit assembly fitted and assembled with the same thickness as the inner wall of the first preheating furnace 410 and may be detachably assembled to the inner wall of the first preheating furnace 410 by an assembly bracket, the support body 420 may be assembled and detached for each section in the inner wall of the first preheating furnace 410.

Consequently, when assembling and configuring the first preheating furnace 410, the total number of assembled support bodies 420 is determined by considering an area of the inner wall formed according to the standard of the first preheating furnace 410, and the support body 420 is disposed by being divided into sections of predetermined sizes of the inner wall of the first preheating furnace 410.

In addition, as illustrated in the accompanying drawings, the heater 421 mounted on the support body 420 by the fixing bracket 422 has an arrangement structure in which a zigzag shape and a parallel shape of one wire is repeatedly mixed to form one continuous line.

That is, one support body 420 has a structure in which one heater 421 is continuously arranged.

Here, as illustrated in FIG. 13, vertically adjacent bent portions of the heater 421 are supported and fixed by a fixing piece fitted to the fixing bracket 422 when the heater 421 is arranged in the zigzag shape and the parallel shape on the support body 420.

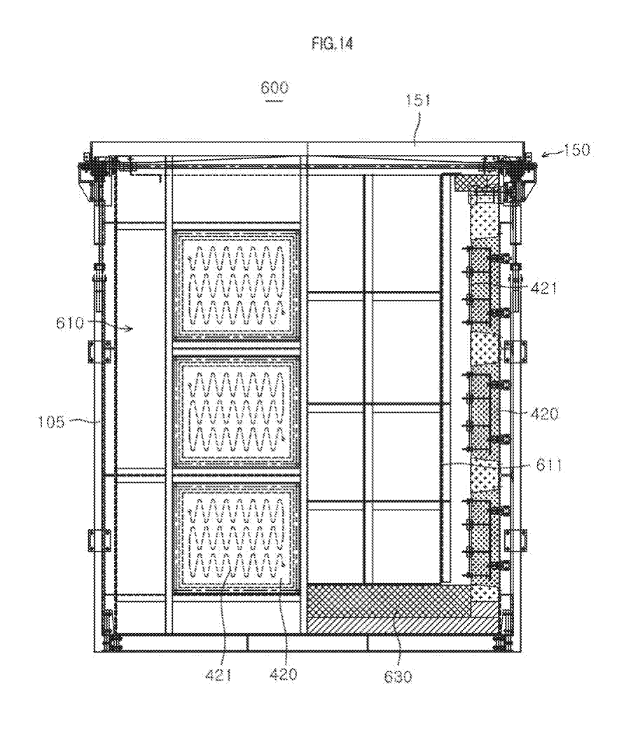

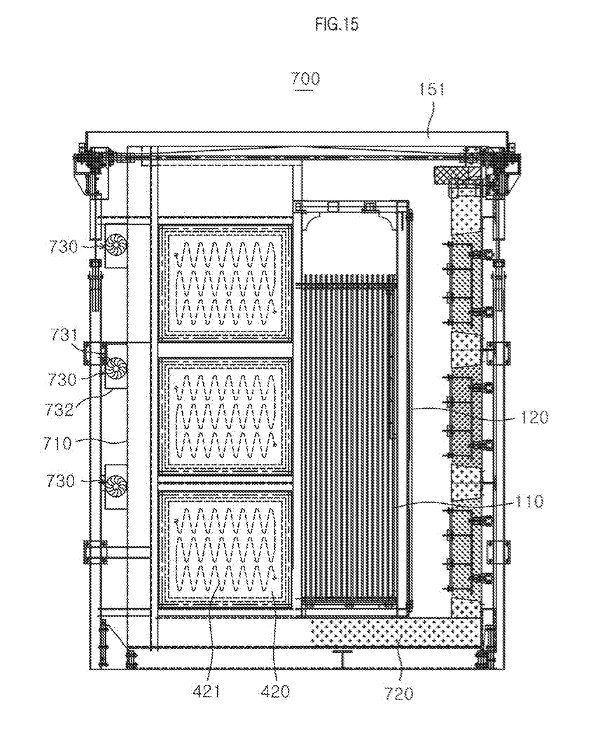

Particularly, as illustrated in the accompanying drawings FIGS. 14 and 15, since the same installation structure is applied to the chemical strengthening furnace 610, the first slow cooling furnace 710, and the second slow cooling furnace (refer to FIG. 4) for the heater 421 installed as above, detailed descriptions on a heat installation structure in the chemical strengthening furnace 610, the first slow cooling furnace 710, and the second slow cooling furnace to be described below will be omitted.

Since even distribution of heat is possible in the arrangement structure of the heater 421 as above, an inner portion of the first preheating furnace 410 may be evenly heated.

Particularly, since the plurality of support bodies 420 are assembled and disposed in the inner wall of the first preheating furnace 410 by being divided into unit assemblies, when the heater 421 on any one support body 420 of the plurality of support bodies 420 has a defect (or a failure), only the support body 420 that includes the heater 421 that has a defect (or a failure) has to be replaced. Thus, compared to conventionally replacing all heaters when a failure of a heater has occurred, the replacement time as well as the replacement cost can be considerably reduced.

Meanwhile, according to the present invention, as illustrated in the process block diagram of FIG. 3, the plate glass 110 is firstly preheated in the first preheating furnace 410 by raising the temperature of the plate glass 110 from room temperature to approximately 200° C. step by step.

A temperature equilibrium in each portion of glass is important in the first preheating step (S2) and the second preheating step (S3) to be described below. Particularly, to prevent a twin that occurs due to a difference between expansive forces of different portions and correlations between inner phases of glass when the plate glass 110 such as a large sheet of glass is only partially heated according to the standard thereof, the plate glass 110 has to be rapidly heated up to a predetermined temperature and then the temperature of the plate glass 10 has to be raised step by step by maintaining the predetermined temperature while repeatedly raising and fixing the temperature.

Specifically, a first preheating temperature in the first preheating furnace 410 starts from room temperature and is raised up to 200° C. step by step through approximately three times according to a thickness, a shape, and a size of glass.

Here, a one-time temperature increase should not exceed 60° C., and a fixed temperature section should be a predetermined number of hours or longer since a sufficient amount of time is required for a temperature equilibrium. In this manner, by raising the preheating temperature while repeatedly raising and fixing the temperature, temperatures of entire portions of glass can be uniformly maintained and damage to the glass can be prevented.

Although the preheating temperature and time are slightly different according to the thickness of plate glass, the preheating treatment is mostly performed for approximately fifteen minutes.

In addition, when the first preheating in the first preheating furnace 410 is finished, the jig 120 on which the firstly preheated plate glass 110 is loaded is transferred to the second preheating furnace (not marked) using the transfer unit 200.

The second preheating furnace has the same structure as the first preheating furnace 410 as mentioned above and secondly preheats the plate glass 110 to a further raised temperature by operating the heater 421.

The second preheating (S3) in the second preheating furnace secondly preheats the plate glass 110 by raising the temperature of the plate glass 110 from 200° C. to 380° C. step by step.

That is, by the same process as the preheating process in the first preheating furnace 410, the plate glass 110 is preheated up to approximately 380° C. step by step while repeatedly raising and fixing the temperature of the plate glass 110 approximately three times according to the thickness, the shape, and the size of the glass also in the second preheating furnace.

Here, although the preheating temperature and time in the second preheating furnace are slightly different according to the thickness of the plate glass 110, the second preheating treatment is mostly performed for approximately fifteen minutes.

Here, when the final second preheating temperature is 380° C. or lower, since it is difficult for sodium ions on a surface of the plate glass 110 to be transferred in the high-temperature chemical strengthening furnace 610 which is the next process due to the plate glass 110 not being sufficiently preheated, there may be a problem of a difficulty in an ion substitution reaction with a KNO₃ solution or a longer reaction time.

Consequently, the plate glass 110 needs to be sufficiently preheated up to the preset final preheating temperature.

The reason for separately providing the first preheating furnace 410 and the second preheating furnace and dividing the process of preheating the plate glass 110 into first and second preheating processes as above is to perform more stable preheating.

Particularly, by separately providing the first preheating furnace 410 and the second preheating furnace, a rotation rate of furnaces according to preheating the plate glass 110 in the first and second preheating processes can be improved.

That is, when the plate glass 110 firstly preheated in the first preheating furnace 410 is transferred to the second preheating furnace, since the first preheating furnace becomes empty, another sheet of plate glass 110 may be naturally and continuously accommodated in the first preheating furnace 410 to continuously perform the first preheating.

Particularly, since the temperature range in the first preheating furnace 410 is from room temperature to approximately 200° C., in dropping the temperature of the first preheating furnace 410 to an initial preheating temperature after first preheating is finished, compared to a conventional case in which a preheating temperature is raised up to 400° C. level and then dropped in one preheating furnace, the process waiting time is saved as well as energy consumption is considerably reduced.

In addition, although not illustrated in the accompanying drawings, temperature sensors are preferably installed in the first and second preheating furnaces for precise temperature control so that a temperature is controlled not to exceed a set value.

Meanwhile, when the plate glass 110 is heated to a high temperature by raising the temperature of the plate glass 110 step by step in the first and second preheating units 400 and 500 and preheating of the plate glass 110 is finished, the plate glass 110 loaded on the jig 120 is transferred to the chemical strengthening unit 600, and the chemical strengthening process by ion substitution is performed. (S4: chemical strengthening)

The plate glass 110 preheated as above is transferred up to the chemical strengthening furnace 610 by the transfer unit 200 and seated.

A schematic view illustrating a configuration of the chemical strengthening furnace 610 according to an embodiment of the present invention is illustrated in FIG. 14.

Ion substitution is performed on the plate glass 110 preheated up to a 380° C. level through the second preheating furnace by the KNO₃ solution in the chemical strengthening furnace 610. (S4: chemical strengthening)

Here, an inner wall of the chemical strengthening furnace 610 is sealed with a stainless steel material and serves as a water bath 611. That is, since KNO₃ is dissolved and accommodated inside the water bath 611, the water bath 611 is preferably formed with a stainless steel (SUS) material having chemical resistance and heat resistance.

The heater 421 divided for each section as described above is disposed in the inner wall of the chemical strengthening furnace 610 to raise the temperature of the chemical strengthening furnace 610 for each strengthening condition.

Particularly, the temperature of each heater 421 is preferably separately controllable.

In addition, although not illustrated in FIG. 14, a heater (not illustrated) is preferably installed also at a lower end of the water bath in the chemical strengthening furnace 610. OF course, the heater installed at a lower end surface of the chemical strengthening furnace 610 is preferably installed to be protected by an insulator 630.

In addition, as described above, the opening-and-closing door 151 is installed in a structure of opening and closing by horizontally sliding at an upper portion of the chemical strengthening furnace 610, and the opening-and-closing door 151 seals the upper portion of the chemical strengthening furnace 610 to perform roles of constantly maintaining the temperature of the KNO₃ solution and preventing heat loss.

In the case of the present invention, the plate glass 110 transferred from the second preheating furnace is dipped in the KNO₃ solution for approximately thirty minutes to one hour in the chemical strengthening furnace 610. Here, small particles (sodium ions) on a surface of the glass are exchanged with large particles (potassium ions) in the dip solution.

That is, when the inner water bath 611 is filled with KNO₃ powder (melting point: 333° C.) for manufacturing the plate glass 110 into tempered glass in the chemical strengthening furnace 610 as in FIG. 14, KNO₃ is liquefied by being heated to 380° C. to 480° C. (preferably, 450° C. to 480° C.), and the plate glass 110 is dipped in the liquefied KNO₃ solution, sodium ions (Na⁺) having a small ion radius distributed on a surface of the plate glass 110 are substituted with potassium ions (K⁺) having a large ion radius in the KNO₃ solution. Here, a compressive stress layer is formed on the surface of the plate glass 110 due to the ion substitution reaction, and thus tempered glass with high surface density is formed.

Here, the dipping time is substantially quite different according to a thickness and a shape of the plate glass 110 and takes into consideration a contact area, Poisson's ratio, a heat absorption rate, a tempering depth, impact resistance, etc.

In addition, the temperature of the KNO₃ solution changes according to the thickness, shape, and size of the plate glass and properties (stiffness, bending) of glass, and an additive is added to KNO₃ to maintain the temperature to be approximately 380° C. to 480° C. (preferably, 450° C. to 480° C.) according to a target temperature.

After the ion substitution is finished in the chemical strengthening furnace 610 as above, the plate glass 110 moves to the first slow cooling furnace 710 of the first slow cooling unit 700 while being loaded on the jig 120 to be cooled. (S5: first cooling).

A schematic view illustrating a configuration of the first slow cooling furnace 710 according to an embodiment of the present invention is illustrated in FIG. 15.

As illustrated in FIG. 15, the first slow cooling furnace 710 that forms the first slow cooling unit 700 has a furnace structure capable of accommodating the jig 120 on which multiple sheets of plate glass 110 are loaded, has the support body 420 in which the heater 421 is disposed by being divided into a plurality of sections assembled in an inner wall thereof, and has a structure that includes the opening-and-closing door 151 for sealing an open upper portion of the furnace.

The first slow cooling furnace 710 having the configuration above performs, for example, a role of firstly cooling the temperature of the plate glass 110 heated in the ion substitution process with KNO₃ ions to approximately 200° C.

By slowly cooling as above, deformation of the ion-substituted plate glass can be prevented as well as residual stress can be removed.

That is, in a reverse order of the first and second preheating furnaces, the temperature of the plate glass 110 raised approximately up to 480° C. is cooled to approximately 200° C. step by step in the first slow cooling furnace 710.

Here, an air circulation means 730 is disposed at an outer circumferential wall of the first slow cooling furnace 710 to allow the step-by-step cooling to be rapidly performed by a rapid air circulation in the first slow cooling furnace 710.

The air circulation means 730 is formed of an air duct 732 disposed to surround an outer circumferential surface of the first slow cooling furnace 710 and a circulation fan 731 disposed in the air duct 732 to circulate air at an in-between portion with the inner portion of the first slow cooling furnace 710.

Meanwhile, in the case of the present invention, as in the preheating process of the plate glass 110 described above, the process of cooling the plate glass 110 is performed by being subdivided into first slow cooling and second slow cooling instead of all cooling processes being performed in one slow cooling furnace as in the related art.

The second slow cooling furnace (not marked) illustrated in FIGS. 4 and 5 and having a detailed configuration and structure that are the same as those of the first slow cooling furnace illustrated in FIG. 15 is disposed in the second slow cooling unit 800.

Consequently, the plate glass 110 whose temperature is dropped approximately to 200° C. as the step-by-step cooling is performed by air in the first slow cooling furnace 710 is transferred to the second slow cooling furnace of the second slow cooling unit 800 to go through the second cooling process by air again. (S6: second cooling)

The second cooling process in the second slow cooling furnace is performed by a step-by-step temperature-dropping process by air as the cooling process in the first slow cooling furnace 710 and cools the temperature of the plate glass 110 approximately to a level around 60° C.

In this manner, the slow cooling process through the first slow cooling furnace 710 and the second slow cooling furnace is a process that determines a stiffness of substituted tempered glass. The glass whose ions are substituted in the chemical strengthening furnace 610 is in an unstable state, and an impact may be applied to the glass as portions bonded to KNO₃ become coagulated.

In addition, a sharp temperature change brings a thermal strengthening effect which is physical strengthening, and an inner crack may occur due to an impact applied to inner original glass (inner glass formed of the original material that is not tempered) caused by a difference between cooling speeds of different parts of the glass.

Consequently, like raising the temperature in the preheating steps, cooling is preferably performed by constant step-by-step cooling in the cooling process.

The temperature-dropping and the temperature-fixing in the first slow cooling furnace 710 and the second slow cooling furnace may be properly controlled by the heater 421 and the air circulation means 730 provided at the inner walls of the first slow cooling furnace 710 and the second slow cooling furnace.

The plate glass 110 cooled through the first and second steps by air cooling as above is supplied to a cleaning bath 910 of the cleaning unit 900 to have the surface thereof cleaned. (S7: cleaning).

Here, the chemically strengthened plate glass 110 stabilized by air cooling as above is put into hot water 920 at 80° C. in equilibrium while being mounted on the jig 120, and the overall temperature of the plate glass 110 is made uniform to stabilize the plate glass 110 one more time.

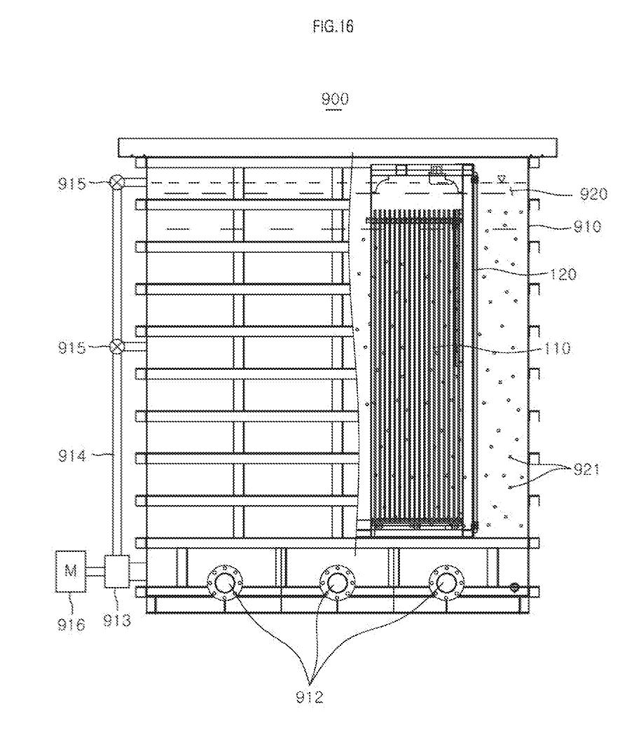

A schematic view illustrating a configuration of the cleaning bath 910 according to an embodiment of the present invention is illustrated in FIG. 16.

The cleaning bath 910 according to the present invention is formed of a box-shaped container with an open upper end capable of accommodating the jig 120 as well as accommodating the hot water 920.

In addition, a plurality of blower connection pipes 912 are connected to and disposed at a lower end portion of an outer wall 911 of the cleaning bath 910 so that air is supplied into the cleaning bath 910 through a bottom surface of the cleaning bath 910.

Here, although not illustrated in the accompanying drawings, a perforated plate having a plurality of fine air holes formed is disposed on the bottom surface of the cleaning bath 910. Thus, air supplied through the blower connection pipes 912 connected to a lower end portion of the cleaning bath 910 is supplied in the form of multiple foams (921, or bubbles) in a process of being distributed and introduced into the air holes of the perforated plate, and cleaning by the foams 921 (so-called, bubble cleaning) becomes possible.

Particularly, since cleaning and cooling of the plate glass 110 are simultaneously performed by the hot water 920 inside the cleaning bath 910, the residual stress of the plate glass 110 formed in the tempering process can be easily removed and thus stabilization of tempered glass can be improved.

Of course, the blower connection pipes 912 are configured to be connected to a blower 913 driven by a motor 916 to supply air to the lower end portion of the cleaning bath 910 from the outside.

In addition, a plurality of air transfer pipes 914 connected to the blower 913 are disposed in a branched structure along the outer wall 911 of the cleaning bath 910 such that air is supplied through the bottom surface of the cleaning bath 910 and air is supplied into the cleaning bath 910 also through the outer wall 911 of the cleaning bath 910 at the same time.

Of course, opening-and-closing valves 915 are mounted at branched portions of the air transfer pipes 914 such that a user may manually or automatically manipulate and control the opening-and-closing valves 915 as needed when controlling an air supply state to be opened or closed or controlling an amount of air supplied.

Here, opening and closing operations of the opening-and-closing valves 915 may be selectively implemented to be manually controlled or automatically controlled. Since a technology for automatically controlling the opening-and-closing valves 915 is a very common technology and those of ordinary skill in the art would not have great difficulty in implementing the technology, detailed description thereof will be omitted.

When air is supplied through the outer wall 911 of the cleaning bath 910 as above, the multiple foams 921 are generated in the hot water 920 accommodated inside the cleaning bath 910, and, at the same time, efficiency of cleaning the plate glass 110 can be improved as the hot water 920 circulates.

The cleaned tempered glass is towed by the transfer unit 201 and discharged through the jig discharge unit 301 to be naturally dried in the air, and, in this way, finishing work for the plate glass manufactured into the tempered glass is completed. (S8: finishing the manufacturing of tempered glass)

Although the tempered glass manufacturing device of the present invention has been described above with reference to the preferred embodiment of the present invention, it should be apparent to those of ordinary skill in the art that modifications, changes, and various modified embodiments are possible within the scope not departing from the spirit of the present invention.

### INDUSTRIAL APPLICABILITY

1. A method for manufacturing tempered glass using chemical strengthening, the method comprising:
preparing plate glass so that plate glass having a predetermined standard is loaded on a jig and transferred to a furnace for each process by a transfer unit;
firstly preheating the plate glass in a first preheating furnace (410) by repeatedly raising and fixing the temperature of the plate glass from room temperature up to 200° C. step by step;
receiving the firstly-preheated plate glass and secondly preheating the plate glass in a second preheating furnace by repeatedly raising and fixing the temperature of the plate glass from 200° C. to 380° C. step by step;
receiving the secondly-preheated plate glass and dipping the plate glass in a KNO₃ solution heated up to 450° C. to 480° C. in a chemical strengthening furnace for thirty minutes to one hour to chemically strengthen the plate glass by ion substitution on a surface of the plate glass;
receiving the chemically-strengthened plate glass and firstly cooling the temperature of the plate glass to 200° C. by repeatedly dropping and fixing the temperature of the plate glass step by step by air cooling in a first slow cooling furnace;
receiving the firstly-cooled plate glass and secondly cooling the temperature of the plate glass to 60° C. by repeatedly dropping and fixing the temperature of the plate glass step by step by air cooling in a second slow cooling furnace;
accommodating the secondly-cooled plate glass in a cleaning bath that contains hot water at 80° C. and then removing KNO₃ remaining on a surface of the plate glass by circulating foams and the hot water using air supplied from a blower connected via pipes to an outer circumferential wall and a bottom surface of the cleaning bath; and
transferring the cleaned plate glass to a jig discharge unit for drying by a natural drying method and finish manufacturing of tempered glass.

2. The method of claim 1, wherein a one-time temperature increase in raising the temperature of the plate glass step by step in the first and second preheating furnaces is preferably lower than 60° C., the one-time temperature increase is controllable to be different according to a standard of plate glass, and a preheating time in each of the first and second preheating furnaces is fifteen minutes.

3. A device for manufacturing tempered glass using chemical strengthening, wherein:
a jig supply unit configured to supply a jig on which plate glass is loaded to be towed and accommodated in a transfer unit, a first preheating unit having the first preheating furnace capable of preheating the plate glass transferred from the jig supply unit through the transfer unit, seated, and accommodated from room temperature up to 200° C. by heating the plate glass while repeatedly raising and fixing the temperature of the plate glass step by step by a heater, a second preheating unit having the second preheating furnace capable of receiving the plate glass preheated in the first preheating furnace and preheating the plate glass from 200° C. to 380° C. by heating the plate glass while repeatedly raising and fixing the temperature of the plate glass step by step by the heater, a chemical strengthening unit having a chemical strengthening furnace formed of a water bath on which the heater is mounted while a KNO₃ solution is retained therein so that the plate glass preheated in the second preheating furnace is received and dipped in the KNO₃ solution heated up to 450° C. to 480° C. for thirty minutes to one hour to enable ion substitution on a surface of the plate glass, a first slow cooling unit having a first slow cooling furnace configured to receive the plate glass chemically strengthened in the chemical strengthening furnace and cool the temperature of the plate glass to 200° C. by repeatedly dropping and fixing the temperature of the plate glass step by step by air cooling, a second slow cooling unit having a second slow cooling furnace configured to receive the firstly-cooled plate glass and secondly cool the temperature of the plate glass to 60° C. by repeatedly dropping and fixing the temperature of the plate glass step by step by air cooling, a cleaning unit having a cleaning bath configured to receive the secondly-cooled plate glass and use hot water to clean and remove KNO₃ remaining on a surface of the plate glass, and a jig discharge unit configured to tow the jig on which the plate glass cleaned in the cleaning bath is loaded to the transfer unit to be discharged are sequentially and separately arranged on the first floor of a structure whose frame is formed by a plurality of support beams; and
box-shaped transfer units with open bottom surfaces are disposed on the second floor of the structure to face each other at the jig supply unit and the jig discharge unit to tow, lift, and lower the jig on which the plate glass is loaded according to a progress of each process while moving along a horizontally installed guide rail.

4. The device for manufacturing tempered glass using chemical strengthening of claim 3, comprising:
a furnace accommodation frame having a shape of a frame formed by a plurality of support beams disposed to surround portions near a furnace to allow the jig transferred by the transfer units to be accommodated in the furnace for each process and be towed;
lifting-and-lowering frames disposed to be lifted and lowered by a cylinder not to interfere with an open surface at an upper end of the furnace on the furnace accommodation frame and, at the same time, seated and assembled to respectively face both side surfaces of the furnace accommodation frame; and
an opening-and-closing door disposed on a rail beam integrally formed with upper ends of the lifting-and-lowering frames to extend relatively longer than the width of the furnace to be opened and closed by sliding along the rail beam toward both sides by an opening-and-closing means.

5. The device for manufacturing tempered glass using chemical strengthening of claim 3, wherein an inner wall of the furnace for each process is divided to be assembled by being divided into a plurality of sections, a support body having a form of a unit assembly corresponding to the size of the divided inner wall of each furnace is detachably disposed by an assembly bracket, and one heater is continuously disposed and fixed on the support body.

6. The device for manufacturing tempered glass using chemical strengthening of claim 3, wherein an air transfer pipe connected to the blower is disposed in a branched structure and connected via pipes to an outer wall of the cleaning bath to supply air inside the cleaning bath for cleaning the surface of the chemically strengthened plate glass with water, a plurality of blower connection pipes connected to the blower are disposed also at a lower end portion of the outer wall of the cleaning bath, and a perforated plate having a plurality of air holes is installed on an inner bottom surface of the cleaning bath.
